(19) United States
(12) Patent Application Publication
(10) Pub. No.: US 2023/0145543 A1
(43) Pub. Date: May 11, 2023

(54) METHOD FOR STATIC IDENTIFICATION OF DAMAGE TO SIMPLY SUPPORTED BEAM UNDER UNCERTAIN LOAD

(71) Applicants: GUANGXI TRANSPORTATION SCIENCE AND TECHNOLOGY GROUP CO., LTD., Nanning, Guangxi (CN); GUANGXI FARMS AGRIBUSINESS DESIGN ACADEMY, Nanning, Guangxi (CN)

(72) Inventors: Yuhou YANG, Nanning (CN); Xian MA, Nanning (CN); Xiaoli ZHUO, Nanning (CN); Longlin WANG, Nanning (CN); Mengsheng YU, Nanning (CN); Hua WANG, Nanning (CN); Shijian LIU, Nanning (CN); Yucai JU, Nanning (CN); Xi PENG, Nanning (CN); Yihao NING, Nanning (CN)

(73) Assignees: GUANGXI TRANSPORTATION SCIENCE AND TECHNOLOGY GROUP CO., LTD., Nanning, Guangxi (CN); GUANGXI FARMS AGRIBUSINESS DESIGN ACADEMY, Nanning, Guangxi (CN)

(21) Appl. No.: 17/915,422

(22) PCT Filed: Oct. 27, 2020
(86) PCT No.: PCT/CN2020/104815

§ 371 Date: Sep. 28, 2022

(30) Foreign Application Priority Data
Mar. 31, 2020 (CN) 202010240575.6

(51) Int. Cl. G06F 30/13; G06F 30/23

(52) U.S. Cl. CPC G06F 30/13; G06F 30/23; G06F 2119/02

(57) ABSTRACT

The present disclosure provides a method for static identification of damage to a simply supported beam under an uncertain load. In this identification method, a beam body is first segmented, and the relationships between key measured sectional rotation angles and the flexural rigidities of segments of a structure under the action of a load are established by using a mechanics principle; then, an applied static load is removed by means of a division operation, and the relative relationships between the flexural rigidities of the segments of the structure are obtained; and finally, these relative relationships are compared with the corresponding relative relationships when the structure is not damaged, so as to determine the position of damage to the structure and assess the amount of damage, such that the static identification for damage to a simply supported beam structure can be completed without calibrating a load in advance.

### TECHNICAL FIELD

The present disclosure belongs to the technical field of civil engineering, and relates to beam structures, in particular to a method for static identification of damage to a simply supported beam under an uncertain load.

### BACKGROUND

As one of the most widely used structural forms in civil engineering, especially in bridge engineering, a simply supported beam structure has the advantages that the mechanical behaviors are clear, and system temperature change, concrete shrinkage and creep, and differential settlement of support do not cause any additional internal force in the beam. Since most of the existing simply supported beam structures are made of concrete, they may suffer unavoidable damage in the running process under the influence of various loads, material aging, environmental erosion, natural disasters and other adverse factors. For the beam structures which are mainly subject to bending, flexural rigidity EI (where E denotes an elastic modulus of the material, and I denotes cross sectional moment of inertia) is one of the most important performance evaluation indexes, and it is often used as an identification index for damage to simply supported beam structures.

At present, there are mainly two methods for identification of damage to simply supported beam structures, namely static identification method and dynamic identification method. The principle of the static identification method is as follows: by applying a certain static load to the structure, the response data (generally including structural deflection and strain) of an identification factor of the structure before and after damage under the static load are measured; since the damage may cause change in structural stiffness or sectional dimension, the response data at the damage location may undergo changes before and after the damage, and thus the damage can be identified. The principle of the dynamic identification method is as follows: the dynamic characteristics of the structure will change once the structure is damaged. By comparing the changes in identification factors which are sensitive to the change of the dynamic characteristics (such as inherent frequency, stiffness matrix, modal shape, damping, energy transfer ratio and strain energy of the structure) before and after damage, the damage to the structure can be identified. Compared with the dynamic identification method, the static identification method has the advantages of high accuracy of measurement data, reliable identification results and simple operation technique, and thus has been widely used a damage identification method in the field of civil engineering. However, limited by its own characteristics, the static identification method requires that the static load applied to the structure be known, and its load value be as accurate as possible. Therefore, the static damage identification method generally requires closed traffic, and poses higher requirements than the dynamic identification method, which hinders the popularization and application of the static damage identification method.

To this end, the present disclosure provides a method for static identification of damage to a simply supported beam under an uncertain load. In this identification method, a beam body is first segmented, and the relationships between key measured sectional rotation angles and the flexural rigidities of segments of a structure under the action of a load are established by using a mechanics principle; then, an applied static load is removed by means of a division operation, and the relative relationships between the flexural rigidities of the segments of the structure are obtained; and finally, these relative relationships are compared with the corresponding relative relationships when the structure is not damaged, so as to determine the position of damage to the structure and assess the amount of damage, such that the static identification for damage to a simply supported beam structure can be completed without calibrating a load in advance.

### SUMMARY

In order to achieve the above objectives, the present disclosure adopts the following technical solution:
a method for static identification of damage to a simply supported beam under an uncertain load, including:
step 1, applying a concentrated load to the simply supported beam by three-point bending, where the applied concentrated load is set to p₁, and acts on a midspan of the beam structure;
step 2, dividing the beam structure into eight equal segments along a key section according to a span l, and assuming that the eight segments have particular flexural rigidities of EIᵣ₁,
$$\frac{1}{{k}_{2}} E {I}_{r 1} , \frac{1}{{k}_{3}} E {I}_{r 1} , \frac{1}{{k}_{4}} E {I}_{r 1} , \frac{1}{{k}_{5}} E {I}_{r 1} , \frac{1}{{k}_{6}} E {I}_{r 1} , \frac{1}{{k}_{7}} E {I}_{r 1} \text{and} \frac{1}{{k}_{8}} E {I}_{r 1} ,$$
and , respectively, where k₂, k₃, k₄, k₅, k₆, k₇ and k₈ each denote a reciprocal of a ratio of the flexural rigidity of each of the second segment, the third segment, the fourth segment, the fifth segment, the sixth segment, the seventh segment and the eighth segment to the flexural rigidity of the first segment;
step 3, arranging a tilt angle sensor at a segment section of the beam structure and at sections of fulcrums at both ends of the beam structure, where the tilt angle sensor is used to measure a rotation angle at which the beam body rotates around a horizontal axis, a measured sectional rotation angle at the fulcrum close to the first segment is θ₀, a measured sectional rotation angle between the first segment and the second segment is θ₁, a measured sectional rotation angle between the second segment and the third segment is θ₂, by analogy, a measured sectional rotation angle between the third segment and the fourth segment is θ₃, a measured sectional rotation angle between the fourth segment and the fifth segment is θ₄, a measured sectional rotation angle between the fifth segment and the sixth segment is θ₅, a measured sectional rotation angle between the sixth segment and the seventh segment is θ₆, a measured sectional rotation angle between the seventh segment and the eighth segment is θ₇, and a measured sectional rotation angle at the fulcrum close to the eighth segment is θ₈;
step 4, solving the following formula by substituting the foregoing measured sectional rotation angles θ₀, - θ₈ to obtain k₂, k₃, k₄, k₅, k₆, k₇ and k₈:
$$\left\{\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; {k}_{4} = \frac{1}{7} \left(\frac{{θ}_{3} - {θ}_{4}}{{θ}_{0} - {θ}_{1}}\right) ; {k}_{5} = \frac{1}{7} \left(\frac{{θ}_{4} - {θ}_{5}}{{θ}_{0} - {θ}_{1}}\right) ; \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right) ;\end{matrix}\right)$$
step 5, establishing a finite element numerical model of the simply supported beam in a damage-free state under a concentrated load p₂ acting on the midspan, extracting the corresponding measured sectional rotation angles in step 3 and setting the same as θ_{0d}, θ_{1d}, θ_{2d}, θ_{3d}, θ_{4d}, θ_{5d}, θ_{6d}, θ_{7d} and θ_{8d}, and calculating, according to the following formula, theoretical values k_{2d}, k₃ₐ, k_{4d}, k_{5d}, k_{6d}, k_{7d} and k_{8d} of the structure in the damage-free state:
$$\left\{\begin{matrix}\begin{matrix}{k}_{2 d} = \frac{1}{3} \left(\frac{{θ}_{1 d} - {θ}_{2 d}}{{θ}_{0 d} - {θ}_{1 d}}\right) ; {k}_{3 d} = \frac{1}{5} \left(\frac{{θ}_{2 d} - {θ}_{3 d}}{{θ}_{0 d} - {θ}_{1 d}}\right) ; \\ {k}_{4 d} = \frac{1}{7} \left(\frac{{θ}_{3 d} - {θ}_{4 d}}{{θ}_{0 d} - {θ}_{1 d}}\right) ; {k}_{5 d} = \frac{1}{7} \left(\frac{{θ}_{4 d} - {θ}_{5 d}}{{θ}_{0 d} - {θ}_{1 d}}\right) ;\end{matrix} \\ {k}_{6 d} = \frac{1}{5} \left(\frac{{θ}_{5 d} - {θ}_{6 d}}{{θ}_{0 d} - {θ}_{1 d}}\right) ; {k}_{7} = \frac{1}{3} \left(\frac{{θ}_{6 d} - {θ}_{7 d}}{{θ}_{0 d} - {θ}_{1 d}}\right) ; {k}_{8} = \left(\frac{{θ}_{7 d} - {θ}_{8 d}}{{θ}_{0 d} - {θ}_{1 d}}\right) ;\end{matrix}\right)$$
step 6, calculating, according to the following formula, a variation of the flexural rigidity of each segment with respect to the structure in the damage-free state:
$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; & \begin{matrix}{Δ}_{3} = \left(\frac{1}{{k}_{3}} - \frac{1}{{k}_{3 d}}\right) / \left(\frac{1}{{k}_{3 d}}\right) \\ \times 100 \% ;\end{matrix} \\ {Δ}_{4} = \left(\frac{1}{{k}_{4}} - \frac{1}{{k}_{4 d}}\right) / \left(\frac{1}{{k}_{4 d}}\right) \times 100 \% ; & \begin{matrix}{Δ}_{5} = \left(\frac{1}{{k}_{5}} - \frac{1}{{k}_{5 d}}\right) / \left(\frac{1}{{k}_{5 d}}\right) \\ \times 100 \% ;\end{matrix} \\ {Δ}_{6} = \left(\frac{1}{{k}_{6}} - \frac{1}{{k}_{6 d}}\right) / \left(\frac{1}{{k}_{6 d}}\right) \times 100 \% ; & \begin{matrix}{Δ}_{7} = \left(\frac{1}{{k}_{7}} - \frac{1}{{k}_{7 d}}\right) / \left(\frac{1}{{k}_{7 d}}\right) \\ \times 100 \% ;\end{matrix} \\ {Δ}_{8} = \left(\frac{1}{{k}_{8}} - \frac{1}{{k}_{8 d}}\right) / \left(\frac{1}{{k}_{8 d}}\right) \times 100 \% & \end{matrix}\right) ;$$
where Δ₂, Δ₃, Δ₄, Δ₅, Δ₆, Δ₇ and Δ₈ respectively denote variations of the flexural rigidities of the second segment, the third segment, the fourth segment, the fifth segment, the sixth segment, the seventh segment and the eighth segment with respect to the structure in the damage-free state; and
step 7, solving following formulas to obtain amounts of damage D₁, D₂, D₃, D₄, D₅, D₆, D₇ and D₈ of the first segment, the second segment, the third segment, the fourth segment, the fifth segment, the sixth segment, the seventh segment and the eighth segment, respectively:
$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right)$$

Further, the concentrated load p₁ applied in step 1 and the concentrated load p₂ applied in the finite element model in step 5 both take an optional value in accordance with a following principle: a maximum value is taken as far as possible under the condition of keeping the structure in an elastic working state; and it is possible that p₁ and p₂ have unequal values.

Further, the measurement accuracy of each sectional rotation angle is not lower than 0.001°.

The present disclosure aims to establish the relative relationships between the flexural rigidities of the segments of the structure by using measurement data of rotation angles of the structure, and provides a method for static identification of damage to a simply supported beam under an uncertain load. In this identification method, a beam body is first segmented, and the relationships between key measured sectional rotation angles and the flexural rigidities of segments of a structure under the action of a load are established by using a mechanics principle; then, an applied static load is removed by means of a division operation, and the relative relationships between the flexural rigidities of the segments of the structure are obtained; and finally, these relative relationships are compared with the corresponding relative relationships when the structure is not damaged, so as to determine the position of damage to the structure and assess the amount of damage, such that the static identification for damage to a simply supported beam structure can be completed without calibrating a load in advance.

Therefore, the present disclosure has the following beneficial effects over the prior art:

1. The identification method provided by the present disclosure can realize the static identification for damage to the simply supported beam structure without calibrating the static load in advance, which reduces the application conditions of the existing method for static identification of damage, and facilitates loading in engineering practice without the need for selecting a specific load for applying.

2. The static identification method provided by the present disclosure is simple and convenient, the static identification for damage to a simply supported beam can be realized simply by arranging a tilt angle sensor on a key section, and no additional workload is needed during an experimental process.

3. The static identification method provided by the present disclosure is achieved by an analytical method, and has universal applicability. That is, regardless of the material of the simply supported beam structure, or the geometrical shape of the section, the damage location and the amount of damage can be accurately identified, as long as the measurement accuracy of the tilt angle of the structure can be guaranteed.

4. The damage location of the simply supported beam can be accurately determined as long as the number of segments is large and the measured sectional rotation angle is sufficient.

### BRIEF DESCRIPTION OF THE DRAWINGS

FIG. 1 is a schematic diagram of an identification method provided by the present disclosure.

FIG. 2 is a schematic diagram of a simply supported beam structure with a uniform section (in a unit of cm).

FIG. 3 is a diagram of a finite element numerical model for a simply supported beam structure with a uniform section (condition 1).

FIG. 4 is a schematic diagram of a simply supported beam structure with a variable section (in a unit of cm).

FIG. 5 is a diagram of a finite element numerical model of a beam structure with a variable section in a damage-free state (concentrated force of 80 kN, and the elastic modulus of C50).

### DETAILED DESCRIPTION OF THE EMBODIMENTS

The present disclosure will be further described with reference to the accompanying drawings and the embodiments below.

Referring to FIG. 1, the present disclosure provides a method for static identification of damage to a simply supported beam under an uncertain load, including:

step 1, apply a concentrated load to the simply supported beam by three-point bending, where the applied concentrated load is set to p₁, and acts on a midspan of the beam structure.

step 2, divide the beam structure into eight equal segments along a key section according to a span l, and assume that the eight segments have particular flexural rigidities of EIᵣ₁,

$$\frac{1}{{k}_{2}} E {I}_{r 1} , \frac{1}{{k}_{3}} E {I}_{r 1} , \frac{1}{{k}_{4}} E {I}_{r 1} , \frac{1}{{k}_{5}} E {I}_{r 1} , \frac{1}{{k}_{6}} E {I}_{r 1} , \frac{1}{{k}_{7}} E {I}_{r 1} \text{and} \frac{1}{{k}_{8}} E {I}_{r 1} ,$$

and respectively, where k₂, k₃, k₄, k₅, k₆, k₇ and k₈ each denote a reciprocal of a ratio of the flexural rigidity of each of the second segment, the third segment, the fourth segment, the fifth segment, the sixth segment, the seventh segment and the eighth segment to the flexural rigidity of the first segment.

step 3, arrange a tilt angle sensor at a segment section of the beam structure and at sections of fulcrums at both ends of the beam structure, where the tilt angle sensor is used to measure a rotation angle at which the beam body rotates around a horizontal axis, a measured sectional rotation angle at the fulcrum close to the first segment is θ₀, a measured sectional rotation angle between the first segment and the second segment is θ₁, a measured sectional rotation angle between the second segment and the third segment is θ₂, by analogy, a measured sectional rotation angle between the third segment and the fourth segment is θ₃, a measured sectional rotation angle between the fourth segment and the fifth segment is θ₄ , a measured sectional rotation angle between the fifth segment and the sixth segment is θ₅, a measured sectional rotation angle between the sixth segment and the seventh segment is θ₆, a measured sectional rotation angle between the seventh segment and the eighth segment is θ₇, and a measured sectional rotation angle at the fulcrum close to the eighth segment is θ₈. Further, in this step, the measurement accuracy of each sectional rotation angle is not lower than 0.001°.

step 4, solve the following formula by substituting the foregoing measured sectional rotation angles θ₀, - θ₈, to obtain k₂, k₃, k₄, k₅, k₆, k₇ and k₈:

$$\left\{\begin{matrix}\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; {k}_{4} = \frac{1}{7} \left(\frac{{θ}_{3} - {θ}_{4}}{{θ}_{0} - {θ}_{1}}\right) ; \\ {k}_{5} = \frac{1}{7} \left(\frac{{θ}_{4} - {θ}_{5}}{{θ}_{0} - {θ}_{1}}\right) ;\end{matrix} \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right) ;\end{matrix}\right)$$

step 5, establish a finite element numerical model of the simply supported beam in a damage-free state under a concentrated load p₂ rotation angle acting on the midspan, extract the corresponding measured sectional rotation angles in step 3 and set the same as θ_{0d}, θ_{1d}, θ_{2d}, θ_{3d}, θ_{4d}, θ_{5d}, θ_{6d}, θ_{7d} and θ_{8d} with a precision of not lower than 0.001°, and calculate, according to the following formula, theoretical values k_{2d}, k_{3d}, k_{4d}, k_{5d}, k_{6d}, k_{7d} and k_{8d} of the structure in the damage-free state:

$$\left\{\begin{matrix}\begin{matrix}{k}_{2 d} = \frac{1}{3} \left(\frac{{θ}_{1 d} - {θ}_{2 d}}{{θ}_{0 d} - {θ}_{1 d}}\right) ; {k}_{3 d} = \frac{1}{5} \left(\frac{{θ}_{2 d} - {θ}_{3 d}}{{θ}_{0 d} - {θ}_{1 d}}\right) ; \\ {k}_{4 d} = \frac{1}{7} \left(\frac{{θ}_{3 d} - {θ}_{4 d}}{{θ}_{0 d} - {θ}_{1 d}}\right) ; {k}_{5 d} = \frac{1}{7} \left(\frac{{θ}_{4 d} - {θ}_{5 d}}{{θ}_{0 d} - {θ}_{1 d}}\right) ;\end{matrix} \\ \begin{matrix}{k}_{6 d} = \frac{1}{5} \left(\frac{{θ}_{5 d} - {θ}_{6 d}}{{θ}_{0 d} - {θ}_{1 d}}\right) ; {k}_{7} = \frac{1}{3} \left(\frac{{θ}_{6 d} - {θ}_{7 d}}{{θ}_{0 d} - {θ}_{1 d}}\right) ; \\ {k}_{8} = \left(\frac{{θ}_{7 d} - {θ}_{8 d}}{{θ}_{0 d} - {θ}_{1 d}}\right) ;\end{matrix}\end{matrix}\right)$$

step 6, calculating, according to the following formula, a variation of the flexural rigidity of each segment with respect to the structure in the damage-free state:

$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; & \begin{matrix}{Δ}_{3} = \left(\frac{1}{{k}_{3}} - \frac{1}{{k}_{3 d}}\right) / \left(\frac{1}{{k}_{3 d}}\right) \\ \times 100 \% ;\end{matrix} \\ {Δ}_{4} = \left(\frac{1}{{k}_{4}} - \frac{1}{{k}_{4 d}}\right) / \left(\frac{1}{{k}_{4 d}}\right) \times 100 \% ; & \begin{matrix}{Δ}_{5} = \left(\frac{1}{{k}_{5}} - \frac{1}{{k}_{5 d}}\right) / \left(\frac{1}{{k}_{5 d}}\right) \\ \times 100 \% ;\end{matrix} \\ {Δ}_{6} = \left(\frac{1}{{k}_{6}} - \frac{1}{{k}_{6 d}}\right) / \left(\frac{1}{{k}_{6 d}}\right) \times 100 \% ; & \begin{matrix}{Δ}_{7} = \left(\frac{1}{{k}_{7}} - \frac{1}{{k}_{7 d}}\right) / \left(\frac{1}{{k}_{7 d}}\right) \\ \times 100 \% ;\end{matrix} \\ {Δ}_{8} = \left(\frac{1}{{k}_{8}} - \frac{1}{{k}_{8 d}}\right) / \left(\frac{1}{{k}_{8 d}}\right) \times 100 \% & ;\end{matrix}\right)$$

where Δ₂, Δ₃, Δ₄, Δ₅, Δ₆, Δ₇ and Δ₈ respectively denote variations of the flexural rigidities of the second segment, the third segment, the fourth segment, the fifth segment, the sixth segment, the seventh segment and the eighth segment with respect to the structure in the damage-free state; and

step 7, solving following formulas to obtain amounts of damage D₁, D₂, D₃, D₄, D₅, D₆, D₇ and D₈ of the first segment, the second segment, the third segment, the fourth segment, the fifth segment, the sixth segment, the seventh segment and the eighth segment, respectively:

$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right) .$$

Further, it should be noted that, the concentrated load p₁ applied in step 1 and the concentrated load p₂ applied in the finite element model in step 5 both take an optional value in accordance with a following principle: a maximum value is taken as far as possible under the condition of keeping the structure in an elastic working state; and it is possible that p₁ and p₂ have unequal values.

In the foregoing steps, step 4 and step 5 are key steps of the present disclosure, and the derivation process of the formulas involved in step 4 and step 5 is described in detail with reference to FIG. 1.

As shown in FIG. 1, known parameters include: a span l, a concentrated load p₁, a measured sectional rotation angle θ₀ at the fulcrum close to the first segment (on the left end of a support), a measured sectional rotation angle θ₁ between the first segment and the second segment (at l / 8), a measured sectional rotation angle θ₂ between the second segment and the third segment (at l / 4), by analogy, a measured sectional rotation angle θ₃ between the third segment and the fourth segment (at 3l / 8), a measured sectional rotation angle θ₄ between the fourth segment and the fifth segment (at l / 2), a measured sectional rotation angle θ₅ between the fifth segment and the sixth segment (at 5l / 8), a measured sectional rotation angle θ₆ between the sixth segment and the seventh segment (at 3l / 4), a measured sectional rotation angle θ₇ between the seventh segment and the eighth segment (at 7l / 8), and a measured sectional rotation angle θ₈ at the fulcrum close to the eighth segment (on the right end of a support); and unknown variables include a flexural rigidity EIᵣ₁ of the first segment, and a reciprocal of a ratio of the flexural rigidity of each of the second segment, the third segment, the fourth segment, the fifth segment, the sixth segment, the seventh segment and the eighth segment to the flexural rigidity of the first segment, which is denoted as k₂, k₃, k₄, k₅, k₆, k₇ and k₈.

In order to solve the above unknown variables, an impulse function S(x) is adopted, which is expressed as:

$$S \left(x\right) = {\left〈x - a\right〉}^{n}$$

Where <> is a Macaulay bracket, x is an unknown variable, a is an arbitrary constant, and n is an exponential. When each variable has different values, the impulse function exhibits different forms, as follows: when

$$n \geq 0 , S \left(x\right) = {\left〈x - a\right〉}^{n} = \left\{\begin{matrix}{\left(x - a\right)}^{n} & x \geq a \\ 0 & x < a\end{matrix}\right)$$

when

$$n < 0 , S \left(x\right) = {\left〈x - a\right〉}^{n} = \left\{\begin{matrix}∞ & x = a \\ 0 & x \neq a\end{matrix}\right)$$

Because of the unique form and definition, the impulse function can avoid the solving of integral constants, which simplifies the workload of calculation in calculus operation. The calculus form of impulse function is summarized as follows:

$$\frac{d S \left(x\right)}{d x} = \left\{\begin{matrix}n {\left〈x - a\right〉}^{n - 1} & n > 0 \\ {\left〈x - a\right〉}^{n - 1} & n \leq 0\end{matrix}\right)$$

$$\int S \left(x\right) d x = \left\{\begin{matrix}\frac{1}{n + 1} {\left〈x - a\right〉}^{n + 1} & n > 0 \\ {\left〈x - a\right〉}^{n + 1} & n \leq 0\end{matrix}\right)$$

The bending rigidity of the beam member shown in FIG. 1 is represented by the pulse function as follows:

$$\frac{1}{B \left(x\right)} = \frac{1}{E {I}_{r 1}} \left[\begin{matrix}1 + \left({k}_{2} - 1\right) {\left〈x - \frac{l}{8}\right〉}^{0} + \left({k}_{3} - {k}_{2}\right) {\left〈x - \frac{2 l}{8}\right〉}^{0} + \\ \left({k}_{4} - {k}_{3}\right) {\left〈x - \frac{3 l}{8}\right〉}^{0} + \left({k}_{5} - {k}_{4}\right) {\left〈x - \frac{4 l}{8}\right〉}^{0} + \\ \left({k}_{6} - {k}_{5}\right) {\left〈x - \frac{5 l}{8}\right〉}^{0} + \left({k}_{7} - {k}_{6}\right) {\left〈x - \frac{6 l}{8}\right〉}^{0} + \\ \left({k}_{8} - {k}_{7}\right) {\left〈x - \frac{7 l}{8}\right〉}^{0}\end{matrix}\right]$$

Based on the Timoshenko beam theory, the basic differential equations of the beam considering the effect of shear deformation are as follows:

$$- \frac{d}{d x} \left[C \left(x\right) \left(\frac{d y}{d x} - φ\right)\right] = q \left(x\right)$$

$$- \frac{d}{d x} \left[B \left(x\right) \frac{d φ}{d x}\right] - C \left(x\right) \left(\frac{d y}{d x} - φ\right) = m \left(x\right)$$

[0062]where y denotes a flexibility of a beam, φ denotes a rotation angle of a beam, C(x) denotes a shearing rigidity of a beam, B(x) denotes a bending rigidity of a beam, and q(x) and m(x) are both load density functions acting on a beam.

As shown in FIG. 1, the impulse function for the load density functions acting on a beam can be expressed as follows:

$$q \left(x\right) = {p}_{1} {\left〈x - \frac{l}{2}\right〉}^{- 1} - \frac{{p}_{1}}{2} \left({\left〈x - 0\right〉}^{- 1} + {\left〈x - l\right〉}^{- 1}\right)$$

$$m \left(x\right) = 0$$

Substitute Formula (9) into Formula (7), and integrate Formula (7) to obtain the following:

$$- C \left(x\right) \left(\frac{d y}{d x} - φ\right) = {p}_{1} {\left〈x - \frac{l}{2}\right〉}^{0} - \frac{{p}_{1}}{2} \left({\left〈x - 0\right〉}^{0} + {\left〈x - l\right〉}^{0}\right)$$

Substitute Formula (11) into Formula (8), and integrate Formula x to obtain the following:

$$B \left(x\right) \frac{d φ}{d x} = {p}_{1} {\left〈x - \frac{1}{2}\right〉}^{1} - \frac{{p}_{1}}{2} \left({\left〈x - 0\right〉}^{1} + {\left〈x - 1\right〉}^{1}\right)$$

Obtain the following rotation angle Formula of the beam member by integrating Formula (12):

$$\begin{matrix}φ \left(x\right) = {φ}_{0} + \left[{p}_{1} \frac{{\left〈x - \frac{1}{2}\right〉}^{2}}{2 !} - \frac{{p}_{1}}{2} \left(\frac{{\left〈x - 0\right〉}^{2}}{2 !} + \frac{{\left〈x - l\right〉}^{2}}{2 !}\right)\right] \left\{\frac{1}{E {I}_{r 1}} \left[\begin{matrix}1 + \left({k}_{2} - 1\right) {\left〈x - \frac{1}{8}\right〉}^{0} + \left({k}_{3} - {k}_{2}\right) {\left〈x - \frac{2 l}{8}\right〉}^{0} + \left({k}_{4} - {k}_{3}\right) {\left〈x - \frac{3 l}{8}\right〉}^{0} + \left({k}_{5} - {k}_{4}\right) {\left〈x - \frac{4 l}{8}\right〉}^{0} \\ + \left({k}_{6} - {k}_{5}\right) {\left〈x - \frac{5 l}{8}\right〉}^{0} + \left({k}_{7} - {k}_{6}\right) {\left〈x - \frac{6 l}{8}\right〉}^{0} + \left({k}_{8} - {k}_{7}\right) {\left〈x - \frac{7 l}{8}\right〉}^{0}\end{matrix}\right]\right\} \\ - \left\{\begin{matrix}\left({k}_{2} - 1\right) \frac{1}{E {I}_{r 1}} \frac{- \frac{{p}_{1}}{2} {\left(\frac{l}{8} - 0\right)}^{2}}{2 !} {\left〈x - \frac{1}{8}\right〉}^{0} + \left({k}_{3} - {k}_{2}\right) \frac{1}{E {I}_{r 1}} \frac{- \frac{{p}_{1}}{2} {\left(\frac{2 l}{8} - 0\right)}^{2}}{2 !} {\left〈x - \frac{2 l}{8}\right〉}^{0} + \left({k}_{4} - {k}_{3}\right) \frac{1}{E {L}_{r 1}} \frac{- \frac{{p}_{1}}{2} {\left(\frac{3 l}{8} - 0\right)}^{2}}{2 !} {\left〈x - \frac{3 l}{8}\right〉}^{0} \\ + \left({k}_{5} - {k}_{4}\right) \frac{1}{E {I}_{r 1}} \frac{- \frac{{p}_{1}}{2} {\left(\frac{4 l}{8} - 0\right)}^{2}}{2 !} {\left〈x - \frac{4 l}{8}\right〉}^{0} + \left({k}_{6} - {k}_{5}\right) \frac{1}{E {I}_{r 1}} \left[\frac{{p}_{1} {\left〈\frac{5 l}{8} - \frac{1}{2}\right〉}^{2}}{2 !} - \frac{\frac{{p}_{1}}{2} {\left(\frac{5 l}{8} - 0\right)}^{2}}{2 !}\right] {\left〈x - \frac{5 l}{8}\right〉}^{0} \\ + \left({k}_{7} - {k}_{6}\right) \frac{1}{E {I}_{r 1}} \left[\frac{{p}_{1} {\left〈\frac{6 l}{8} - \frac{l}{2}\right〉}^{2}}{2 !} - \frac{\frac{{p}_{1}}{2} {\left(\frac{6 l}{8} - 0\right)}^{2}}{2 !}\right] {\left〈x - \frac{6 l}{8}\right〉}^{0} + \left({k}_{8} - {k}_{7}\right) \frac{1}{E {I}_{r 1}} \left[\frac{{p}_{1} {\left〈\frac{7 l}{8} - \frac{l}{2}\right〉}^{2}}{2 !} - \frac{\frac{{p}_{1}}{2} {\left(\frac{7 l}{8} - 0\right)}^{2}}{2 !}\right] {\left〈x - \frac{7 l}{8}\right〉}^{0}\end{matrix}\right\}\end{matrix}$$

By substituting into Formula (13) the measured rotation angles at the left-ended support and the right-ended support, and at the segments of the beam member, the following formulas can be obtained:

$$\left\{\begin{matrix}φ \left(\frac{l}{8}\right) = {θ}_{0} - \frac{{l}^{2} {p}_{1}}{256 E {L}_{r 1}} = {θ}_{1} \\ φ \left(\frac{2 l}{8}\right) = {θ}_{0} - \frac{\left(1 + 3 {k}_{2}\right) {l}^{2} {p}_{1}}{256 E {I}_{r 1}} = {θ}_{2} \\ φ \left(\frac{3 l}{8}\right) = {θ}_{0} - \frac{\left(1 + 3 {k}_{2} + 5 {k}_{3}\right) {l}^{2} {p}_{1}}{256 E {L}_{r 1}} = {θ}_{3} \\ φ \left(\frac{4 l}{8}\right) = {θ}_{0} - \frac{\left(1 + 3 {k}_{2} + 5 {k}_{3} + 7 {k}_{4}\right) {l}^{2} {p}_{1}}{256 E {L}_{r 1}} = {θ}_{4} \\ φ \left(\frac{5 l}{8}\right) = {θ}_{0} - \frac{\left(1 + 3 {k}_{2} + 5 {k}_{3} + 7 {k}_{4} + 7 {k}_{5}\right) {l}^{2} {p}_{1}}{256 E {L}_{r 1}} = {θ}_{5} \\ φ \left(\frac{6 l}{8}\right) = {θ}_{0} - \frac{\left(1 + 3 {k}_{2} + 5 {k}_{3} + 7 {k}_{4} + 7 {k}_{5} + 5 {k}_{6}\right) {l}^{2} {p}_{1}}{256 E {L}_{r 1}} = {θ}_{6} \\ φ \left(\frac{7 l}{8}\right) = {θ}_{0} - \frac{\left(1 + 3 {k}_{2} + 5 {k}_{3} + 7 {k}_{4} + 7 {k}_{5} + 5 {k}_{6} + 3 {k}_{7}\right) {l}^{2} {p}_{1}}{256 E {L}_{r 1}} = {θ}_{7} \\ φ \left(l\right) = {θ}_{0} - \frac{\left(1 + 3 {k}_{2} + 5 {k}_{3} + 7 {k}_{4} + 7 {k}_{5} + 5 {k}_{6} + 3 {k}_{7} + {k}_{8}\right) {l}^{2} {p}_{1}}{256 E {L}_{r 1}} = {θ}_{8}\end{matrix}\right)$$

Turn Formula (14) to Formula (15) through equivalent transformation

$$\left\{\begin{matrix}{θ}_{0} - {θ}_{1} = \frac{{l}^{2} {p}_{1}}{256 E {L}_{r 1}} ( 1 ) \\ {θ}_{0} - {θ}_{2} = \frac{\left(1 + 3 {k}_{2}\right) {l}^{2} {p}_{1}}{256 E {I}_{r 1}} ( 2 ) \\ {θ}_{0} - {θ}_{3} = \frac{\left(1 + 3 {k}_{2} + 5 {k}_{3}\right) {l}^{2} {p}_{1}}{256 E {L}_{r 1}} ( 3 ) \\ {θ}_{0} - {θ}_{4} = \frac{\left(1 + 3 {k}_{2} + 5 {k}_{3} + 7 {k}_{4}\right) {l}^{2} {p}_{1}}{256 E {L}_{r 1}} ( 4 ) \\ {θ}_{0} - {θ}_{5} = \frac{\left(1 + 3 {k}_{2} + 5 {k}_{3} + 7 {k}_{4} + 7 {k}_{5}\right) {l}^{2} {p}_{1}}{256 E {L}_{r 1}} ( 5 ) \\ {θ}_{0} - {θ}_{6} = \frac{\left(1 + 3 {k}_{2} + 5 {k}_{3} + 7 {k}_{4} + 7 {k}_{5} + 5 {k}_{6}\right) {l}^{2} {p}_{1}}{256 E {L}_{r 1}} ( 6 ) \\ {θ}_{0} - {θ}_{7} = \frac{\left(1 + 3 {k}_{2} + 5 {k}_{3} + 7 {k}_{4} + 7 {k}_{5} + 5 {k}_{6} + 3 {k}_{7}\right) {l}^{2} {p}_{1}}{256 E {L}_{r 1}} ( 7 ) \\ {θ}_{0} - {θ}_{8} = \frac{\left(1 + 3 {k}_{2} + 5 {k}_{3} + 7 {k}_{4} + 7 {k}_{5} + 5 {k}_{6} + 3 {k}_{7} + {k}_{8}\right) {l}^{2} {p}_{1}}{256 E {L}_{r 1}} ( 8 )\end{matrix}\right)$$

As can be seen from Formula (15), each term contains and therefore, k₂ can be solved by division operation, namely dividing Formula II by Formula I. Then obtain k₃ by dividing Formula III by Formula II, and substituting into k₂ solved aforesaid. Solve k₄, k₅, k₆, k₇ and k₈ in sequence in this way, and the final result is shown in the following formula:

$$\left\{\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; {k}_{4} = \frac{1}{7} \left(\frac{{θ}_{3} - {θ}_{4}}{{θ}_{0} - {θ}_{1}}\right) ; {k}_{5} = \frac{1}{7} \left(\frac{{θ}_{4} - {θ}_{5}}{{θ}_{0} - {θ}_{1}}\right) ; \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right)\end{matrix}\right)$$

In the present disclosure, step 5 of the static identification method provided is also carried out in accordance with the above method, except that the rotation angle is extracted according to the finite element model in the damage-free state of the structure, rather than measured in practice. Therefore, by replacing the measured rotation angles in Formula (16) with the extracted values in the finite element model, obtain the ratio of flexural rigidity of each segment with respect to the first segment of structure in the damage-free state, namely, values k_{2d}, k_{3d}, k_{4d}, k_{5d}, k_{6d}, k_{7d}, and k_{8d} in the theoretical state, as seen in Formula (17).

$$\left\{\begin{matrix}{k}_{2 d} = \frac{1}{3} \left(\frac{{θ}_{1 d} - {θ}_{2 d}}{{θ}_{0 d} - {θ}_{1 d}}\right) ; {k}_{3 d} = \frac{1}{5} \left(\frac{{θ}_{2 d} - {θ}_{3 d}}{{θ}_{0 d} - {θ}_{1 d}}\right) ; {k}_{4 d} = \frac{1}{7} \left(\frac{{θ}_{3 d} - {θ}_{4 d}}{{θ}_{0 d} - {θ}_{1 d}}\right) ; {k}_{5 d} = \frac{1}{7} \left(\frac{{θ}_{4 d} - {θ}_{5 d}}{{θ}_{0 d} - {θ}_{1 d}}\right) ; \\ {k}_{6 d} = \frac{1}{5} \left(\frac{{θ}_{5 d} - {θ}_{6 d}}{{θ}_{0 d} - {θ}_{1 d}}\right) ; {k}_{7} = \frac{1}{3} \left(\frac{{θ}_{6 d} - {θ}_{7 d}}{{θ}_{0 d} - {θ}_{1 d}}\right) ; {k}_{8} = \left(\frac{{θ}_{7 d} - {θ}_{8 d}}{{θ}_{0 d} - {θ}_{1 d}}\right)\end{matrix}\right)$$

When merely the relative relationship is considered, the flexural rigidity of the first segment is “1”, then the measured flexural rigidity of the second segment of the structure is 1 / k₂, and the flexural rigidity of other segment can be calculated likewise. For the second segment of the structure in a damage-free state, the flexural rigidity is 1 / k_{2d}, and the flexural rigidity of the other segment can be calculated in a similar way. At this time, the variation of the flexural rigidity of each segment of the structure can be obtained relative to the damage-free state, as given in Formula (18).

$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; & {Δ}_{3} = \left(\frac{1}{{k}_{3}} - \frac{1}{{k}_{3 d}}\right) / \left(\frac{1}{{k}_{3 d}}\right) \times 100 \% ; \\ {Δ}_{4} = \left(\frac{1}{{k}_{4}} - \frac{1}{{k}_{4 d}}\right) / \left(\frac{1}{{k}_{4 d}}\right) \times 100 \% ; & {Δ}_{5} = \left(\frac{1}{{k}_{5}} - \frac{1}{{k}_{5 d}}\right) / \left(\frac{1}{{k}_{5 d}}\right) \times 100 \% ; \\ {Δ}_{6} = \left(\frac{1}{{k}_{6}} - \frac{1}{{k}_{6 d}}\right) / \left(\frac{1}{{k}_{6 d}}\right) \times 100 \% ; & {Δ}_{7} = \left(\frac{1}{{k}_{7}} - \frac{1}{{k}_{7 d}}\right) / \left(\frac{1}{{k}_{7 d}}\right) \times 100 \% ; \\ {Δ}_{8} = \left(\frac{1}{{k}_{8}} - \frac{1}{{k}_{8 d}}\right) / \left(\frac{1}{{k}_{8 d}}\right) \times 100 \% & \end{matrix}\right)$$

Then, the relative amount of damage of the flexural rigidity for the first segment is the maximum value of these variations, and the amount of damage of another segment is the difference between the variation of the flexural rigidity of the segment and the maximum value. Since merely the amount of damage is the factor of concern, absolute values are taken, and the final calculation Formula is shown in Formula (19):

$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right)$$

The method provided in the present disclosure is described in detail below by taking the simply supported concrete beam structure with a uniform section and the simply supported concrete beam structure with a variable section as embodiments respectively, in combination with the results of finite element numerical analysis.

### Embodiment 1: Simply Supported Concrete Beam With a Uniform Section

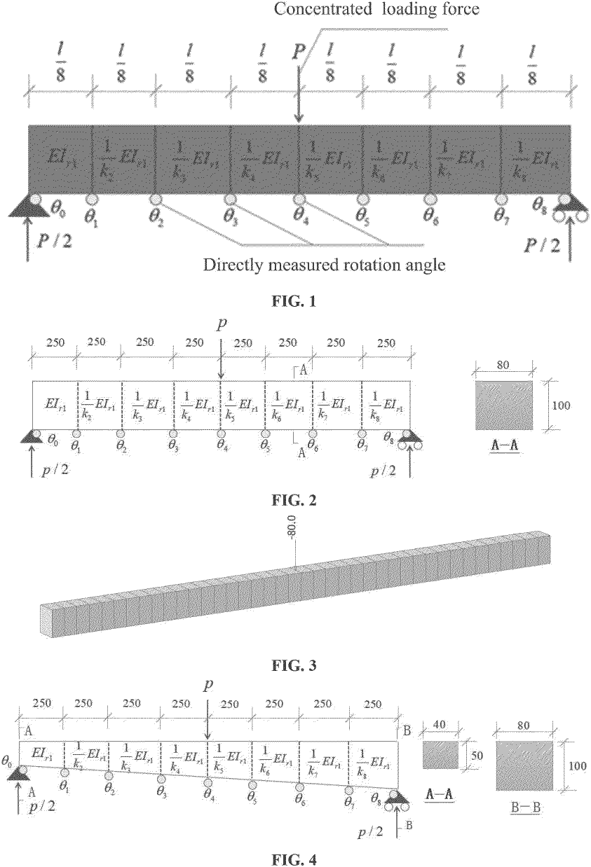

A concrete beam with a uniform section has a span of 20 m, a concrete strength grade of C50, a beam height of 1 m and a beam width of 0.8 m. The schematic diagram of the beam structure is shown in FIG. 2, and the finite element numerical model is shown in FIG. 3. Different damage conditions are set, as shown in Table 1.

TABLE 1

Settings for damage conditions of a simply supported beam with a uniform section

| Damage conditio n | Detailed content | Concentrated force P applied at midspan | Remarks |
|---|---|---|---|
| 1 | In case where the elastic modulus of C50 is taken, none of the segments are subject to damage. | 80 kN | Verify the accuracy of the method provided in the present disclosure |
| 2 | In case where the elastic modulus is 1.2 times that of C50, none of the segments are subject to damage. | 100 kN | In engineering practice, the elastic modulus of the new structure is generally greater than a design value |
| 3 | In case where the elastic modulus is 1.2 times that of C50, only the first segment is subject to a 10% damage of flexural rigidity | 120 kN | / |
| 4 | In case where the elastic modulus is 1.2 times that of C50, the amounts of damage for the flexural rigidity of the first segment, the third segment, the fifth segment, and the eighth segment are 10%, 5%, 15%, and 5%, respectively. | 100 kN | / |
| 5 | In case where the elastic modulus of C50 is taken, the amounts of damage for the flexural rigidity of the first segment, the second segment, the third segment, the sixth segment, and the seventh segment are 5%, 5%, 5%, 10% and 10%, respectively. | 120 kN | / |

The calculation process is described in detail by using damage condition 1 as an example, and only the final results are given for other damage conditions. Damage condition 1 indicates no damage and a uniform section, so there is no need to establish a finite element numerical model, and it follows that: k_{2d} =k_{3d} =k_{4d} =k_{5d} =k_{6d} =k_{7d} =k_{8d} =1. According to FIG. 2 and Table 1, each measured sectional tilt angle under condition 1 is calculated by finite element method, as shown in Table 2.

TABLE 2

Calculation for the tilt angle of a simply supported beam with a uniform section condition 1)

| No. | Tilt angle/ ° | |
|---|---|---|
| 1 | θ₀ | 0.0498 |
| 2 | θ₁ | 0.0467 |
| 3 | θ₂ | 0.0374 |
| 4 | θ₃ | 0.0218 |
| 5 | θ₄ | 0 |
| 6 | θ₅ | -0.0218 |
| 7 | θ₆ | -0.0374 |
| 8 | θ₇ | -0.0467 |
| 9 | θ₈ | -0.0498 |

Note: The tilt angle is positive in the clockwise direction, and negative in the counterclockwise direction.

The values of k₂ , k₃, k₄, k₅, k₆, k₇ and k₈ are calculated according to the following formula, and the results are listed in Table 3.

$$\left\{\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; {k}_{4} = \frac{1}{7} \left(\frac{{θ}_{3} - {θ}_{4}}{{θ}_{0} - {θ}_{1}}\right) ; {k}_{5} = \frac{1}{7} \left(\frac{{θ}_{4} - {θ}_{5}}{{θ}_{0} - {θ}_{1}}\right) ; \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right)\end{matrix}\right)$$

The values of Δ₂, Δ₃, Δ₄, Δ₅, Δ₆, Δ₇ and Δ₈ are calculated according to the following formula, and the results are listed in Table 3.

$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; & {Δ}_{3} = \left(\frac{1}{{k}_{3}} - \frac{1}{{k}_{3 d}}\right) / \left(\frac{1}{{k}_{3 d}}\right) \times 100 \% ; \\ {Δ}_{4} = \left(\frac{1}{{k}_{4}} - \frac{1}{{k}_{4 d}}\right) / \left(\frac{1}{{k}_{4 d}}\right) \times 100 \% ; & {Δ}_{5} = \left(\frac{1}{{k}_{5}} - \frac{1}{{k}_{5 d}}\right) / \left(\frac{1}{{k}_{5 d}}\right) \times 100 \% ; \\ {Δ}_{6} = \left(\frac{1}{{k}_{6}} - \frac{1}{{k}_{6 d}}\right) / \left(\frac{1}{{k}_{6 d}}\right) \times 100 \% ; & {Δ}_{7} = \left(\frac{1}{{k}_{7}} - \frac{1}{{k}_{7 d}}\right) / \left(\frac{1}{{k}_{7 d}}\right) \times 100 \% ; \\ {Δ}_{8} = \left(\frac{1}{{k}_{8}} - \frac{1}{{k}_{8 d}}\right) / \left(\frac{1}{{k}_{8 d}}\right) \times 100 \% & \end{matrix}\right)$$

The amounts of damage D₁, D₂, D₃, D₄, D₅, D₆, D₇ and D₈ of the first segment, the second segment, the third segment, the fourth segment, the fifth segment, the sixth segment, the seventh segment and the eighth segment are calculated, respectively according to the following formula, and the results are listed in Table 3.

$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right)$$

TABLE 3

Damage identification for beam with a uniform section (damage condition 1)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 0 |
| k₂ | 1 | Δ₂ | 0 | D₂ | 0 |
| k₃ | 1.006452 | Δ₃ | -0.64% | D₃ | 0.64% |
| k₄ | 1.004608 | Δ₄ | -0.46% | D₄ | 0.46% |
| k₅ | 1.004608 | Δ₅ | -0.46% | D₅ | 0.46% |
| k₆ | 1.006452 | Δ₆ | -0.64% | D₆ | 0.64% |
| k₇ | 1 | Δ₇ | 0 | D₇ | 0 |
| k₈ | 1 | Δ₈ | 0 | D₈ | 0 |

Note: Under damage condition 1, the elastic modulus of C50 is set, and none of the segments are subject to damage.

As shown in Table 3, the amount of damage in flexural rigidity of each segment is close to 0, and has a maximum value of 0.64%, which is consistent with the assumption that there is no damage in damage condition 1, indicating that the method provided in the present disclosure is accurate and feasible, and is high in damage identification accuracy. According to the above method, the calculation results of damage identification for each beam under damage condition 2 to damage condition 5 are listed in Table 4 to Table 7, respectively.

TABLE 4

Damage identification for simply supported beam with a uniform section (damage condition 2)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 2.06% |
| k₂ | 0.979798 | Δ₂ | 2.06% | D₂ | 0 |
| k₃ | 0.981818 | Δ₃ | 1.85% | D₃ | 0.21% |
| k₄ | 0.982684 | Δ₄ | 1.76% | D₄ | 0.30% |
| k₅ | 0.982684 | Δ₅ | 1.76% | D₅ | 0.30% |
| k₆ | 0.981818 | Δ₆ | 1.85% | D₆ | 0.21% |
| k₇ | 0.979798 | Δ₇ | 2.06% | D₇ | 0 |
| k₈ | 1 | Δ₈ | 0 | D₈ | 2.06% |

Note: Under damage condition 2, the elastic modulus is 1.2 times that of C50, and none of the segments are subject to damage.

TABLE 5

Damage identification for a beam with a uniform section (damage condition 3)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 13.79% |
| k₂ | 0.878788 | Δ₂ | 13.79% | D₂ | 0 |
| k₃ | 0.886364 | Δ₃ | 12.82% | D₃ | 0.97% |
| k₄ | 0.886364 | Δ₄ | 12.82% | D₄ | 0.97% |
| k₅ | 0.883117 | Δ₅ | 13.24% | D₅ | 0.56% |
| k₆ | 0.886364 | Δ₆ | 12.82% | D₆ | 0.97% |
| k₇ | 0.878788 | Δ₇ | 13.79% | D₇ | 0 |
| k₈ | 0.886364 | Δ₈ | 12.82% | D₈ | 0.97% |

Note: Under damage condition 3, the elastic modulus is 1.2 times that of C50, and only the first segment is subject to a 10% damage of flexural rigidity.

TABLE 6

Damage identification for a beam with a uniform section (damage condition 4)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 11.34% |
| k₂ | 0.898148 | Δ₂ | 11.34% | D₂ | 0.00% |
| k₃ | 0.95 | Δ₃ | 5.26% | D₃ | 6.08% |
| k₄ | 0.900794 | Δ₄ | 11.01% | D₄ | 0.33% |
| k₅ | 1.059524 | Δ₅ | -5.62% | D₅ | 16.96% |
| k₆ | 0.9 | Δ₆ | 11.11% | D₆ | 0.23% |
| k₇ | 0.907407 | Δ₇ | 10.20% | D₇ | 1.14% |
| k₈ | 0.944444 | Δ₈ | 5.88% | D₈ | 5.46% |

Note: Under damage condition 4, the elastic modulus is 1.2 times that of C50, and the amounts of damage for the flexural rigidity of the first segment, the third segment, the fifth segment, and the eighth segment are 10%, 5%, 15%, and 5%, respectively.

TABLE 7

Damage identification for a beam with a uniform section (damage condition 5)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 4.89% |
| k₂ | 1 | Δ₂ | 0.00% | D₂ | 4.89% |
| k₃ | 1.004082 | Δ₃ | -0.41% | D₃ | 5.30% |
| k₄ | 0.953353 | Δ₄ | 4.89% | D₄ | 0 |
| k₅ | 0.953353 | Δ₅ | 4.89% | D₅ | 0 |
| k₆ | 1.061224 | Δ₆ | -5.77% | D₆ | 10.66% |
| k₇ | 1.054422 | Δ₇ | -5.16% | D₇ | 10.05% |
| k₈ | 0.959184 | Δ₈ | 4.26% | D₈ | 0.64% |

Note: Under condition 5, the elastic modulus of C50 is set, and the amounts of damage for the flexural rigidity of the first segment, the second segment, the third segment, the sixth segment, and the seventh segment are 5%, 5%, 5%, 10% and 10%, respectively.

As can be seen from Table 4 to Table 7, the amounts of damage identified according to the method of the present disclosure are basically the same as those set in advance under various damage conditions. Thus, under the condition of guaranteeing the measurement accuracy of the tilt angle, damage location and evaluation on amounts of damage for damage to a simply supported beam can be conducted by adopting the method of the present disclosure.

### Embodiment 2: Simply Supported Concrete Beam With a Variable Section

A concrete beam with a variable section has a span of 20 m and a concrete strength grade of C50, and a rectangular section is adopted. From the left-ended section, the beam has a height of 0.5 m and a width of 0.4 m; while from the right-ended section, the beam has a height of 1 m and a width of 0.8 m; and the left-ended section changes linearly to the right-ended section, and at this time, the structural diagram is shown in FIG. 4. Different damage conditions are manually set, as listed in Table 8.

TABLE 8

Settings for damage conditions of a simply supported beam with a variable section

| Damage condition | Detailed content | Concentrated force P applied at midspan |
|---|---|---|
| 1 | In case where the elastic modulus is 1.2 times that of C50, only the first segment is subject to a 10% damage of flexural rigidity | 80 kN |
| 2 | In case where the elastic modulus is 1.2 times that of C50, the amounts of damage for the flexural rigidity of the first segment, the third segment, the fifth segment, and the eighth segment are 10%, 5%, 15%, and 5%, respectively. | 180 kN |
| 3 | In case where the elastic modulus of C50 is taken, the amounts of damage for the flexural rigidity of the first segment, the second segment, the third segment, the sixth segment, and the seventh segment are 5%, 5%, 5%, 10% and 10%, respectively. | 80 kN |

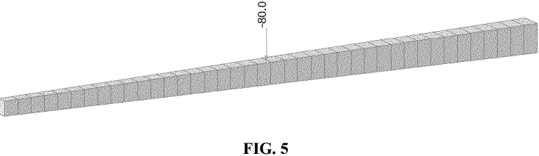

The calculation process is described in detail by using damage condition 1 as an example, and only the final results are given for other conditions. Under damage condition 1, in the simply supported beam with a variable section, only the first segment is subject to a 10% damage of flexural rigidity. For this reason, it is required to first establish a finite element numerical model of the structure in a damage-free state. The finite element numerical model diagram is shown in FIG. 5, and the tilt angle of the ⅛ section of the structure is extracted, and based on the extracted tilt angle, values of k_{2d}, k_{3d}, k_{4d}, k_{5d}, k_{6d}, k_{7d} and k_{8d} are calculated according to the following formula in the invention. The calculated results and tilt angles are shown in Table 9:

$$\left\{\begin{matrix}{k}_{2 d} = \frac{1}{3} \left(\frac{{θ}_{1 d} - {θ}_{2 d}}{{θ}_{0 d} - {θ}_{1 d}}\right) ; {k}_{3 d} = \frac{1}{5} \left(\frac{{θ}_{2 d} - {θ}_{3 d}}{{θ}_{0 d} - {θ}_{1 d}}\right) ; {k}_{4 d} = \frac{1}{7} \left(\frac{{θ}_{3 d} - {θ}_{4 d}}{{θ}_{0 d} - {θ}_{1 d}}\right) ; {k}_{5 d} = \frac{1}{7} \left(\frac{{θ}_{4 d} - {θ}_{5 d}}{{θ}_{0 d} - {θ}_{1 d}}\right) ; \\ {k}_{6 d} = \frac{1}{5} \left(\frac{{θ}_{5 d} - {θ}_{6 d}}{{θ}_{0 d} - {θ}_{1 d}}\right) ; {k}_{7} = \frac{1}{3} \left(\frac{{θ}_{6 d} - {θ}_{7 d}}{{θ}_{0 d} - {θ}_{1 d}}\right) ; {k}_{8} = \left(\frac{{θ}_{7 d} - {θ}_{8 d}}{{θ}_{0 d} - {θ}_{1 d}}\right)\end{matrix}\right)$$

TABLE 9

Calculation for the tilt angle of a simply supported beam structure with a variable section under a damage-free state

| No. | tilt angle/ ° | | Reciprocal of flexural rigidity of each of the second segment, the third segment, the fourth segment, the fifth segment, the sixth segment, the seventh segment and the eighth segment with respect to the first segment | |
|---|---|---|---|---|
| 1 | θ_{0d} | 0.2359 | / | / |
| 2 | θ_{1d} | 0.1995 | k_{2d} | 0.677655677655678 |
| 3 | θ_{2d} | 0.1255 | k_{3d} | 0.458791208791209 |
| 4 | θ_{3d} | 0.042 | k_{4d} | 0.319858712715856 |
| 5 | θ_{4d} | -0.0395 | k_{5d} | 0.232731554160126 |
| 6 | θ_{5d} | -0.0988 | k_{6d} | 0.170879120879121 |
| 7 | θ_{6d} | -0.1299 | k_{7d} | 0.129120879120879 |
| 8 | θ_{7d} | -0.144 | k_{8d} | 0.104395604395604 |
| 9 | θ_{8d} | -0.1478 | / | / |

Note: The tilt angle is positive in the clockwise direction, and negative in the counterclockwise direction.

In order to obtain the tilt angle of ⅛ section of the beam with a variable section under damage condition 1, the finite element numerical model of the structure is established (the elastic modulus of concrete is 1.2 times that of C50, and only the first segment is subject to a 10% damage of flexural rigidity). The measured sectional tilt angle at this time is extracted, and the extraction results are given in Table 10.

TABLE 10

Calculation for measured sectional tilt angles of a simply supported beam structure with a variable section (damage condition 1)

| No. | Tilt angle/ ° | |
|---|---|---|
| 1 | θ₀ | 0.3995 |
| 2 | θ₁ | 0.332 |
| 3 | θ₂ | 0.2086 |
| 4 | θ₃ | 0.0694 |
| 5 | θ₄ | -0.0664 |
| 6 | θ₅ | -0.1652 |
| 7 | θ₆ | -0.2171 |
| 8 | θ₇ | -0.2406 |
| 9 | θ₈ | -0.2468 |

Note: The tilt angle is positive in the clockwise direction, and negative in the counterclockwise direction.

From the measured sectional tilt angles described above, the values of k₂, k₃, k₄, k₅, k₆, k₇ and k₈ are calculated according to the following formula in the present disclosure, and the calculation results are given in Table 11:

$$\left\{\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; {k}_{4} = \frac{1}{7} \left(\frac{{θ}_{3} - {θ}_{4}}{{θ}_{0} - {θ}_{1}}\right) ; {k}_{5} = \frac{1}{7} \left(\frac{{θ}_{4} - {θ}_{5}}{{θ}_{0} - {θ}_{1}}\right) ; \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right)\end{matrix}\right)$$

Based on the obtained values k₂, k₃, k₄, k₅, k₆, k₇ and k₈, the values of Δ₂, Δ₃, Δ₄, Δ₅, Δ₆, Δ₇ and Δ₈ are calculated according to the following formula in the present disclosure, and the calculation results are given in Table 11:

$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; & {Δ}_{3} = \left(\frac{1}{{k}_{3}} - \frac{1}{{k}_{3 d}}\right) / \left(\frac{1}{{k}_{3 d}}\right) \times 100 \% ; \\ {Δ}_{4} = \left(\frac{1}{{k}_{4}} - \frac{1}{{k}_{4 d}}\right) / \left(\frac{1}{{k}_{4 d}}\right) \times 100 \% ; & {Δ}_{5} = \left(\frac{1}{{k}_{5}} - \frac{1}{{k}_{5 d}}\right) / \left(\frac{1}{{k}_{5 d}}\right) \times 100 \% ; \\ {Δ}_{6} = \left(\frac{1}{{k}_{6}} - \frac{1}{{k}_{6 d}}\right) / \left(\frac{1}{{k}_{6 d}}\right) \times 100 \% ; & {Δ}_{7} = \left(\frac{1}{{k}_{7}} - \frac{1}{{k}_{7 d}}\right) / \left(\frac{1}{{k}_{7 d}}\right) \times 100 \% ; \\ {Δ}_{8} = \left(\frac{1}{{k}_{8}} - \frac{1}{{k}_{8 d}}\right) / \left(\frac{1}{{k}_{8 d}}\right) \times 100 \% & \end{matrix}\right)$$

Based on the obtained values Δ₂, Δ₃, Δ₄, Δ₅, Δ₆, Δ₇ and Δ₈, the amounts of damage D₁, D₂, D₃, D₄, D₅, D₆, D₇ and D₈ of the first segment, the second segment, the third segment, the fourth segment, the fifth segment, the sixth segment, the seventh segment and the eighth segment are calculated, respectively according to the following formula, and the calculation results are given in Table 3.

$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right)$$

TABLE 11

Damage identification for a beam with a variable section (damage condition 1)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 13.66% |
| k₂ | 0.609382716049383 | Δ₂ | 11.20% | D₂ | 2.45% |
| k₃ | 0.412444444444444 | Δ₃ | 11.24% | D₃ | 2.42% |
| k₄ | 0.287407407407407 | Δ₄ | 11.29% | D₄ | 2.37% |
| k₅ | 0.209100529100529 | Δ₅ | 11.30% | D₅ | 2.36% |
| k₆ | 0.153777777777778 | Δ₆ | 11.12% | D₆ | 2.54% |
| k₇ | 0.116049382716049 | Δ₇ | 11.26% | D₇ | 2.39% |
| k₈ | 0.091851851851852 | Δ₈ | 13.66% | D₈ | 0 |

Note: Under damage condition 1, the elastic modulus is 1.2 times that of C50, and only the first segment is subject to a 10% damage of flexural rigidity.

As can be seen from Table 11, by adoption of the method, it is determined that the first segment is subject to a 13.66% damage of flexural rigidity, which is 3.66% greater than 10% damage set in advance for the present condition, and this error is within an acceptable scope. The error is mainly caused by the measurement accuracy of tilt angles. According to the above method, the calculation results of damage identification for each beam under damage condition 2 and damage condition 3 are given in Table 12 and Table 13, respectively.

TABLE 12

Damage identification for a beam with a variable section (damage condition 2)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 11.37% |
| k₂ | 0.609574000878349 | Δ₂ | 11.17% | D₂ | 0.20% |
| k₃ | 0.434255599472991 | Δ₃ | 5.65% | D₃ | 5.72% |
| k₄ | 0.287596461509505 | Δ₄ | 11.22% | D₄ | 0.15% |
| k₅ | 0.246188594014681 | Δ₅ | -5.47% | D₅ | 16.83% |
| \k₆ | 0.153886693017128 | Δ₆ | 11.04% | D₆ | 0.32% |
| k₇ | 0.115942028985507 | Δ₇ | 11.37% | D₇ | 0 |
| k₈ | 0.097496706192358 | Δ₈ | 7.08% | D₈ | 4.29% |

Note: Under damage condition 2, the elastic modulus is 1.2 times that of C50, the amounts of damage for the flexural rigidity of the first segment, the third segment, the fifth segment, and the eighth segment are 10%, 5%, 15%, and 5%, respectively.

TABLE 13

Damage identification for a beam with a uniform section (damage condition 3)

| Reciprocal of flexural rigidity of each segment relative to the first segment | Value | Variation in flexural rigidity of each segment | Value | Amount of damage in flexural rigidity of each segment | Value |
|---|---|---|---|---|---|
| / | / | / | / | D₁ | 8.06% |
| k₂ | 0.678851174934726 | Δ₂ | -0.18% | D₂ | 8.24% |
| k₃ | 0.459007832898172 | Δ₃ | -0.05% | D₃ | 8.11% |
| k₄ | 0.303618052965311 | Δ₄ | 5.35% | D₄ | 2.71% |
| [k₅ | 0.221186124580380 | Δ₅ | 5.22% | D₅ | 2.84% |
| k₆ | 0.180678851174935 | Δ₆ | -5.42% | D₆ | 13.49% |
| k₇ | 0.136640557006092 | Δ₇ | -5.50% | D₇ | 13.57% |
| k₈ | 0.096605744125326 | Δ₈ | 8.06% | D₈ | 0 |

Note: Under condition 3, the elastic modulus of C50 is set, and the amounts of damage for the flexural rigidity of the first segment, the second segment, the third segment, the sixth segment, and the seventh segment are 5%, 5%, 5%, 10% and 10%,

As can be seen from Table 12 and Table 13, the method provided in the present disclosure has high precision in identifying the damage to a damaged simply supported beam with a variable section, and the maximum error between the amount of damage identified and the preset amount of damage is 3.57%, which is within the acceptable range of engineering error. This proves the accuracy and feasibility of the method provided in the present disclosure.

It should be noted that in the method of the present disclosure, the relative relationship of flexural rigidities between the segments is made use of (thereby shielding the load effect), and the relative amount of damage of each segment is obtained. As results obtained are not the absolute values of the flexural rigidities, it is impossible to determine the bearing capacity of the whole structure directly according to the results in the present disclosure. However, it is feasible to conduct damage location and evaluation on the relative amount of damage of each segment according to the results in the present disclosure.

According to the idea of the present disclosure, the applied load can be changed randomly according to the actual situation (that is, it is possible to apply a load of any form, such as uniformly distributed force, trapezoidal load, bending moment, etc.), and the number of rotations for rotation angle measurement can also be added, that is, the number of segments of the beam structure can also be increased (the more segments are, the more accurate the damage location is). Hence, it is feasible to carry out static identification of damage to a simply supported beam under an uncertain load based on the method of the present disclosure. The present disclosure is only one of the common cases, and any change based on the method of the present disclosure shall fall within the protection scope of the present disclosure.

What is claimed is:

1. A method for static identification of damage to a simply supported beam under an uncertain load, comprising:
step 1, applying a concentrated load to the simply supported beam by three-point bending, wherein the applied concentrated load is set to p₁, and acts on a midspan of the beam structure;
step 2, dividing the beam structure into eight equal segments along a key section according to a span l, and assuming that the eight segments have particular flexural rigidities of EIᵣ₁,
$$\frac{1}{{k}_{2}} E {I}_{r 1} , \frac{1}{{k}_{3}} E {I}_{r 1} , \frac{1}{{k}_{4}} E {I}_{r 1} , \frac{1}{{k}_{5}} E {I}_{r 1} , \frac{1}{{k}_{6}} E {I}_{r 1} , \frac{1}{{k}_{7}} E {I}_{r 1} \text{and} \frac{1}{{k}_{8}} E {I}_{r 1} ,$$
respectively, wherein k₂, k₃, k₄, k₅, k₆, k₇ and k₈ each denote a reciprocal of a ratio of the flexural rigidity of each of the second segment, the third segment, the fourth segment, the fifth segment, the sixth segment, the seventh segment and the eighth segment to the flexural rigidity of the first segment;
step 3, arranging a tilt angle sensor at a segment section of the beam structure and at sections of fulcrums at both ends of the beam structure, wherein the tilt angle sensor is used to measure a rotation angle at which the beam body rotates around a horizontal axis, a measured sectional rotation angle at the fulcrum close to the first segment is θ₀, a measured sectional rotation angle between the first segment and the second segment is θ₁, a measured sectional rotation angle between the second segment and the third segment is θ₂, by analogy, a measured sectional rotation angle between the third segment and the fourth segment is θ₃, a measured sectional rotation angle between the fourth segment and the fifth segment is θ₄, a measured sectional rotation angle between the fifth segment and the sixth segment is θ₅, a measured sectional rotation angle between the sixth segment and the seventh segment is θ₆, a measured sectional rotation angle between the seventh segment and the eighth segment is θ₇, and a measured sectional rotation angle at the fulcrum close to the eighth segment is θ₈;
step 4, solving the following formula by substituting the foregoing measured sectional rotation angles θ₀ - θ₈ to obtain k₂, k₃, k₄, k₅, k₆, k₇ and k₈:
$$\begin{matrix}\left\{\begin{matrix}{k}_{2} = \frac{1}{3} \left(\frac{{θ}_{1} - {θ}_{2}}{{θ}_{0} - {θ}_{1}}\right) ; {k}_{3} = \frac{1}{5} \left(\frac{{θ}_{2} - {θ}_{3}}{{θ}_{0} - {θ}_{1}}\right) ; \text{} \text{} \text{} {k}_{4} = \frac{1}{7} \left(\frac{{θ}_{3} - {θ}_{4}}{{θ}_{0} - {θ}_{1}}\right) ; {k}_{5} = \frac{1}{7} \left(\frac{{θ}_{4} - {θ}_{5}}{{θ}_{0} - {θ}_{1}}\right) ; \\ {k}_{6} = \frac{1}{5} \left(\frac{{θ}_{5} - {θ}_{6}}{{θ}_{0} - {θ}_{1}}\right) ; {k}_{7} = \frac{1}{3} \left(\frac{{θ}_{6} - {θ}_{7}}{{θ}_{0} - {θ}_{1}}\right) ; {k}_{8} = \left(\frac{{θ}_{7} - {θ}_{8}}{{θ}_{0} - {θ}_{1}}\right)\end{matrix}\right) \\ ;\end{matrix}$$
step 5, establishing a finite element numerical model of the simply supported beam in a damage-free state under a concentrated load P₂ acting on the midspan, extracting the corresponding measured sectional rotation angles in step 3 and setting the same as θ_{0d}, θ_{1d}, θ_{2d}, θ_{3d}, θ_{4d}, θ_{5d}, θ_{6d}, θ_{7d} and θ_{8d}, and calculating, according to the following formula, theoretical values k_{2d}, k_{3d}, k_{4d}, k_{5d}, k_{6d}, k_{7d} and k_{8d} of the structure in the damage-free state:
$$\begin{matrix}\left\{\begin{matrix}{k}_{2 d} = \frac{1}{3} \left(\frac{{θ}_{1 d} - {θ}_{2 d}}{{θ}_{0 d} - {θ}_{1 d}}\right) ; {k}_{3 d} = \frac{1}{5} \left(\frac{{θ}_{2 d} - {θ}_{3 d}}{{θ}_{0 d} - {θ}_{1 d}}\right) ; {k}_{4 d} = \frac{1}{7} \left(\frac{{θ}_{3 d} - {θ}_{4 d}}{{θ}_{0 d} - {θ}_{1 d}}\right) ; {k}_{5 d} = \frac{1}{7} \left(\frac{{θ}_{4 d} - {θ}_{5 d}}{{θ}_{0 d} - {θ}_{1 d}}\right) ; \\ {k}_{6 d} = \frac{1}{5} \left(\frac{{θ}_{5 d} - {θ}_{6 d}}{{θ}_{0 d} - {θ}_{1 d}}\right) ; {k}_{7} = \frac{1}{3} \left(\frac{{θ}_{6 d} - {θ}_{7 d}}{{θ}_{0 d} - {θ}_{1 d}}\right) ; {k}_{8} = \left(\frac{{θ}_{7 d} - {θ}_{8 d}}{{θ}_{0 d} - {θ}_{1 d}}\right)\end{matrix}\right) \\ ;\end{matrix}$$
step 6, calculating, according to the following formula, a variation of the flexural rigidity of each segment with respect to the structure in the damage-free state:
$$\left\{\begin{matrix}{Δ}_{2} = \left(\frac{1}{{k}_{2}} - \frac{1}{{k}_{2 d}}\right) / \left(\frac{1}{{k}_{2 d}}\right) \times 100 \% ; {Δ}_{3} = \left(\frac{1}{{k}_{3}} - \frac{1}{{k}_{3 d}}\right) / \left(\frac{1}{{k}_{3 d}}\right) \times 100 \% ; \\ {Δ}_{4} = \left(\frac{1}{{k}_{4}} - \frac{1}{{k}_{4 d}}\right) / \left(\frac{1}{{k}_{4 d}}\right) \times 100 \% ; {Δ}_{5} = \left(\frac{1}{{k}_{5}} - \frac{1}{{k}_{5 d}}\right) / \left(\frac{1}{{k}_{5 d}}\right) \times 100 \% ; \\ {Δ}_{6} = \left(\frac{1}{{k}_{6}} - \frac{1}{{k}_{6 d}}\right) / \left(\frac{1}{{k}_{6 d}}\right) \times 100 \% ; {Δ}_{7} = \left(\frac{1}{{k}_{7}} - \frac{1}{{k}_{7 d}}\right) / \left(\frac{1}{{k}_{7 d}}\right) \times 100 \% ; \\ {Δ}_{8} = \left(\frac{1}{{k}_{8}} - \frac{1}{{k}_{8 d}}\right) / \left(\frac{1}{{k}_{8 d}}\right) \times 100 \% ; ;\end{matrix}\right)$$
wherein Δ₂, Δ₃, Δ₄, Δ₅, Δ₆, Δ₇ and Δ₈ respectively denote variations of the flexural rigidities of the second segment, the third segment, the fourth segment, the fifth segment, the sixth segment, the seventh segment and the eighth segment with respect to the structure in the damage-free state; and
step 7, solving following formulas to obtain amounts of damage D₁, D₂, D₃, D₄, D₅, D₆, D₇ and D₈ of the first segment, the second segment, the third segment, the fourth segment, the fifth segment, the sixth segment, the seventh segment and the eighth segment, respectively:
$$\left\{\begin{matrix}{D}_{1} = max \left\{{Δ}_{2} , {Δ}_{3} , {Δ}_{4} , {Δ}_{5} , {Δ}_{6} , {Δ}_{7} , {Δ}_{8}\right\} ; \\ {D}_{2} = \left|{Δ}_{2} - {D}_{1}\right| ; {D}_{3} = \left|{Δ}_{3} - {D}_{1}\right| ; {D}_{4} = \left|{Δ}_{4} - {D}_{1}\right| ; {D}_{5} = \left|{Δ}_{5} - {D}_{1}\right| ; \\ {D}_{6} = \left|{Δ}_{6} - {D}_{1}\right| ; {D}_{7} = \left|{Δ}_{7} - {D}_{1}\right| ; {D}_{8} = \left|{Δ}_{8} - {D}_{1}\right|\end{matrix}\right)$$
.

2. The method for static identification of damage to a simply supported beam under an uncertain load according to claim 1, wherein the concentrated load p₁ applied in step 1 and the concentrated load p₂ applied in the finite element model in step 5 both take an optional value in accordance with a following principle: a maximum value is taken as far as possible under the condition of keeping the structure in an elastic working state; and it is possible that p₁ and p₂ have unequal values.

3. The method for static identification of damage to a simply supported beam under an uncertain load according to claim 1, wherein the measurement accuracy of each sectional rotation angle is not lower than 0.001°.
